(19) United States
(12) Patent Application Publication
(10) Pub. No.: US 2010/0166907 A1
(43) Pub. Date: Jul. 1, 2010

(54) INJECTION MOLD HAVING WORKPIECE TRIMMING EDGE

(75) Inventor: HSIEH-TING HUANG, Miao-Li County (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP., Miao-Li County (TW)

(21) Appl. No.: 12/629,969

(22) Filed: Dec. 3, 2009

(30) Foreign Application Priority Data
Dec. 30, 2008 (CN) 200810306677.2

(51) Int. Cl. B29C 45/38; B29C 45/27; B29C 45/40

(52) U.S. Cl. 425/554; 425/572

(57) ABSTRACT

An exemplary injection mold includes a stationary mold, a movable mold, and an ejection device. The stationary mold includes a stationary core received therein. The stationary core includes a stationary molding surface. The movable mold includes a movable core corresponding to the stationary core. The movable core includes a movable molding surface and defines an injection channel. When the injection mold is closed, the stationary molding surface and the movable molding surface cooperatively define a molding cavity of a configuration corresponding to that of an article to be molded, with the injection channel communicates with the molding cavity. The ejection device includes a knockout pin passing through the movable mold and terminating at the molding cavity. The knockout pin includes a trimming edge having a sharp tip protruding into a top end of the injection channel.

### CROSS-REFERENCE TO RELATED APPLICATION

This application is related to a co-pending U.S. patent application Ser. No. 12/607,171, filed on Oct. 28, 2009, and entitled “INJECTION MOLD WITH WORKPIECE TRIMMING EDGE,” wherein the inventor is Hsieh-Ting Huang. That application has the same assignee as the present application. The disclosures of the above identified application are incorporated herein by reference.

### BACKGROUND

1. Technical Field

The present disclosure generally relates to injection molds and, particularly, to an injection mold with a knockout pin that has a trimming edge.

2. Description of Related Art

Injection molds are widely used for fabricating plastic articles. Referring to FIG. 5, a commonly used injection mold 10 includes a stationary mold 11, a movable mold 12, a mold base 13, and an ejection device 14. The mold base 13 supports the stationary mold 11, the movable mold 12, and the ejection device 14. The stationary mold 11 includes a female core 111 positioned therein. The movable mold 12 includes a male core 121 positioned therein, corresponding to the female core 111. To close the injection mold 10, the movable mold 12 and the stationary mold 11 are pressed against each other such that the female core 111 and the male core 121 cooperatively define a molding cavity 151 (a space which can be filled with molten plastic) of a configuration corresponding to that of an article to be molded. The ejection device 14 includes an ejector retainer plate 141, and a plurality of eject pins 142 fixed to the ejector retainer plate 141. The ejector retainer plate 141 drives the eject pins 142 to eject the plastic article molded in the molding cavity 151 out of the male core 121. To improve the surface quality of the outer surface of the molded plastic article adjacent to the stationary mold 11, the male core 121 generally defines an injection channel 152 oriented parallel to the ejection direction and communicating with the molding cavity 151. The female core 111 and the male core 121 cooperatively define a runner 153 communicating with the injection channel 152, such that molten plastic injected into the runner 153 can flow into the molding cavity 151 from the injection channel 152.

Referring also to FIG. 6, when opening the injection mold 10, the movable mold 12 is detached from the stationary mold 11, and the eject pins 142 are driven by the ejector retainer plate 141 to eject the plastic article solidified in the molding cavity 151 together with the excess material (not labeled) formed in the injection channel 152 out of the male core 121.

Thus, the excess material remains connected to the plastic article, and must be severed and removed manually or by a cutting appliance. This requires more manpower or machine power, and adds to the fabrication time. Thus the time to market and costs are correspondingly increased. Overall, the fabrication efficiency for the article is relatively poor.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a cross-section of one embodiment of an injection mold shown in a closed state, with a plastic article formed by the injection mold inside.

FIG. 2 is an enlarged view of a circled portion II of FIG. 1.

FIG. 3 is similar to FIG. 1, but shows the injection mold in an open state.

FIG. 4 is an enlarged view showing successive stages in a process of the injection mold of FIG. 1 severing and removing excess material from the plastic article.

FIG. 5 is a cross-section of a commonly used injection mold shown in a closed state, with a plastic article formed by the injection mold inside.

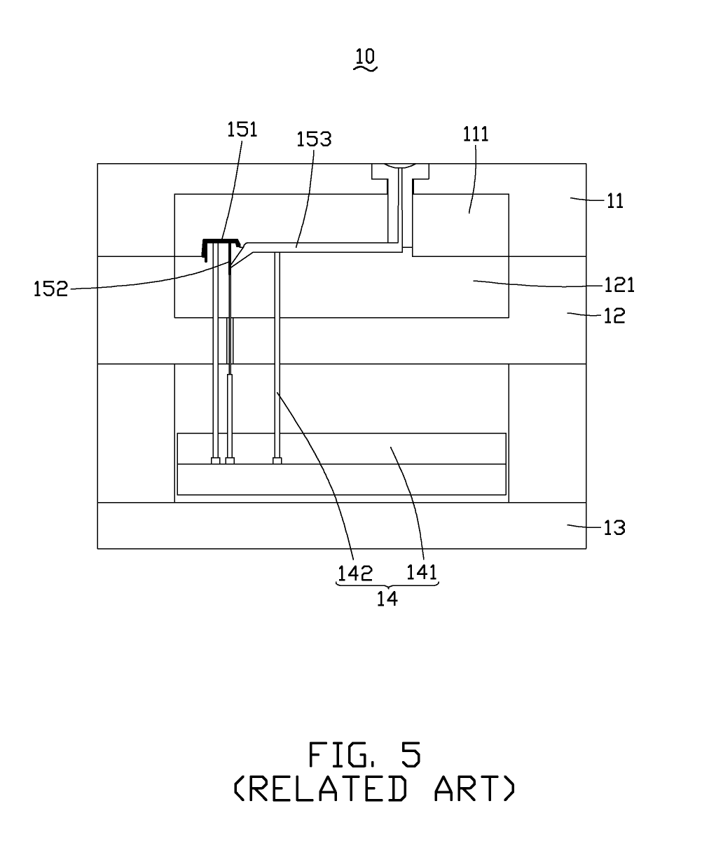

FIG. 6 is similar to FIG. 5, but shows the injection mold in an open state.

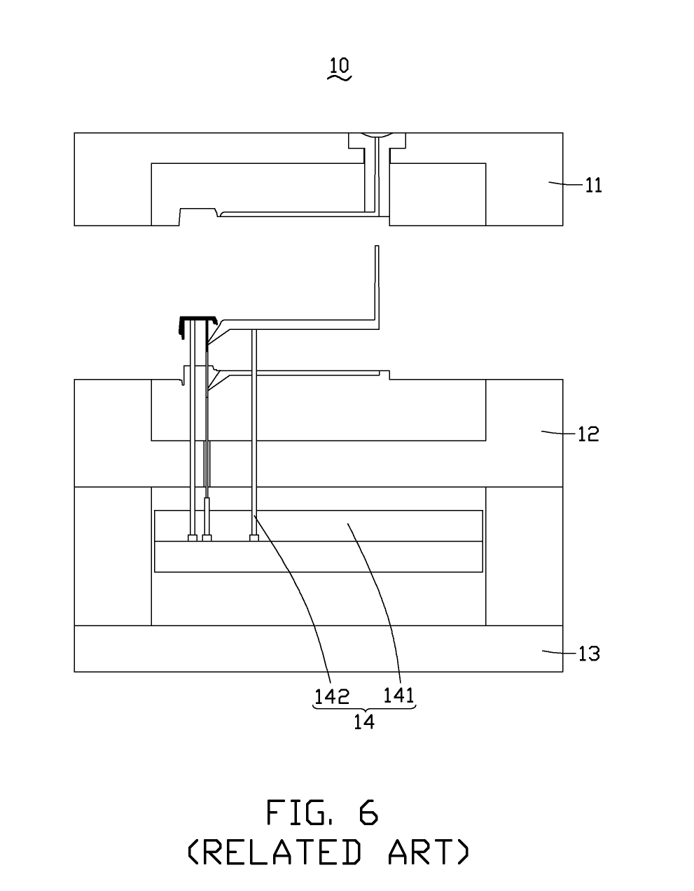

### DETAILED DESCRIPTION

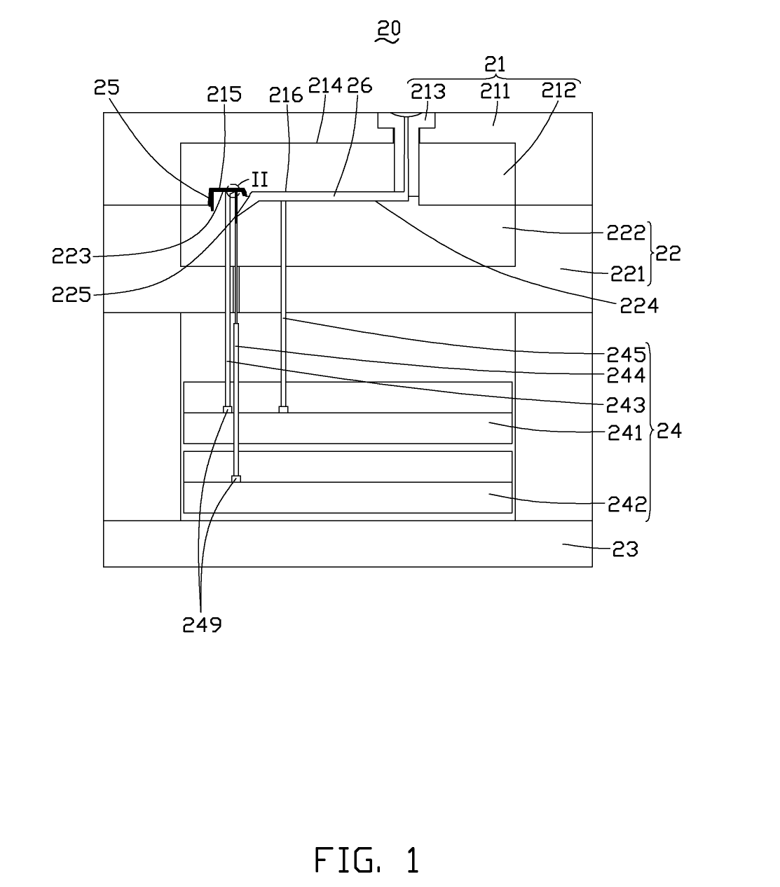

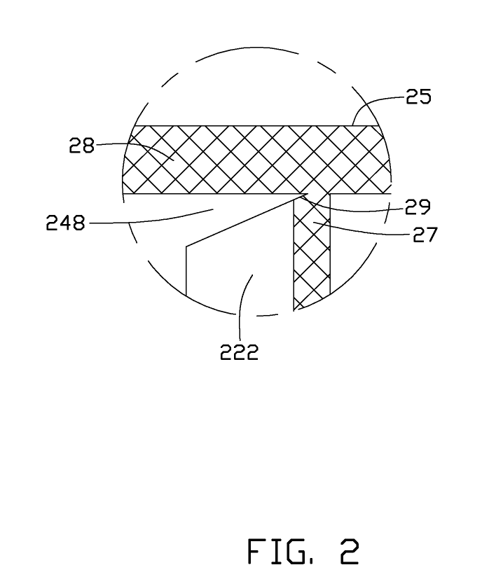

Referring to FIGS. 1 and 2, one embodiment of an injection mold 20 includes a stationary mold 21, a movable mold 22, a mold base 23, and an ejection device 24. The mold base 23 supports the stationary mold 21, the movable mold 22, and the ejection device 24. The ejection device 24 is positioned between the movable mold 22 and the mold base 23.

The stationary mold 21 includes a stationary mold frame 211 and a stationary core 212, and defines a gate 213. The stationary mold frame 211 defines a receiving chamber 214 therein. The stationary core 212 is received in the receiving chamber 214. The stationary core 212 includes a work surface (not labeled) facing the movable mold 22. The work surface includes a stationary molding surface 215, and a stationary runner surface 216 adjoining the stationary molding surface 215. The gate 213 runs through the stationary mold frame 211 and the stationary core 212, and communicates with the runner surface 216.

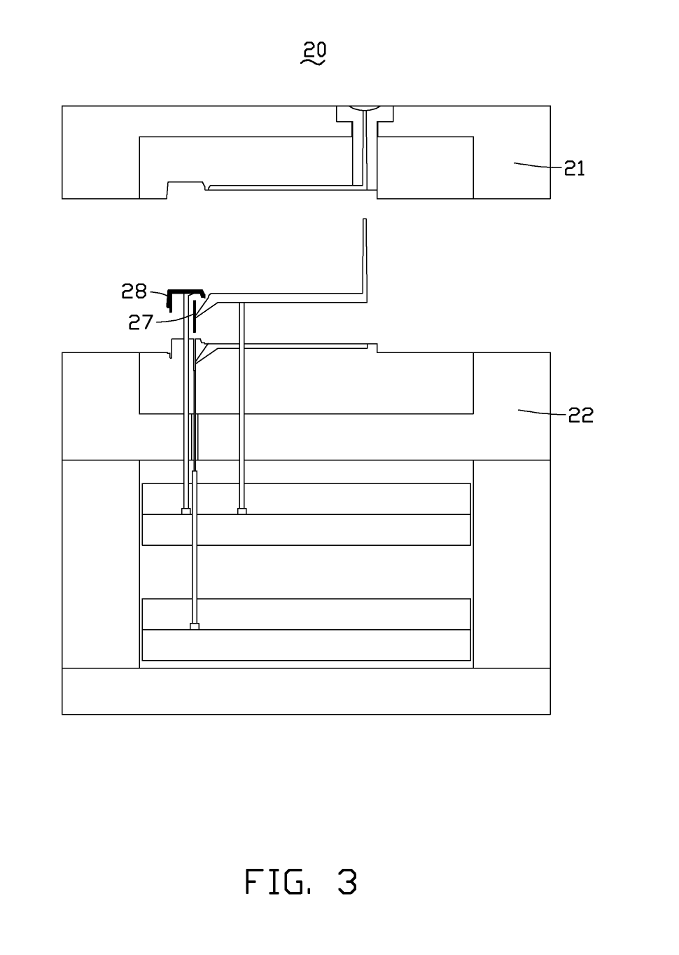

The movable mold 22 includes a movable mold frame 221, and a movable core 222 received in the movable mold frame 221. The movable core 222 includes a movable molding surface 223 and a movable runner surface 224, and defines an injection channel 225. When the injection mold 20 is closed, the stationary mold 21 and the movable mold 22 are pressed against each other, such that the stationary molding surface 215 and the movable molding surface 223 cooperatively define a molding cavity 25 of a configuration corresponding to that of a plastic article 28 to be molded (see FIG. 3). The stationary runner surface 216 and the movable runner surface 224 cooperatively define a runner 26 communicating with the gate 213. The injection channel 225 is defined in the movable core 222 in a direction parallel to the movement of the movable mold 22, and spans to a topmost portion of the movable molding surface 223. A first (top) end of the injection channel 225 communicates with the molding cavity 25, and a second (bottom) end of the injection channel 225 communicates with the runner 26.

The ejection device 24 includes an ejector retainer plate 241, an ejector base plate 242 parallel and adjacent to the ejector retainer plate 241, a knockout pin 243, a sprue injection pin 244, and a runner injection pin 245. A first (bottom) end of the knockout pin 243 includes a fixing head 249 fixed to the ejector retainer plate 241, and a second (top) end of the knockout pin 243 passes through the movable mold 22 and terminates at the molding cavity 25. The knockout pin 243 includes a trimming edge 248 adjacent to the injection channel 225. The trimming edge 248 includes a sharp tip (not labeled) protruding slightly into a top end of the injection channel 225, such that a corner of the movable core 222 where the injection channel 225 communicates with the molding cavity 25 is in the form of a sharp protrusion or ridge (not labeled). A first (bottom) end of the sprue injection pin 244 includes a fixing head 249 fixed to the ejector base plate 242, and a second (top) end of the sprue injection pin 244 passes through the movable mold 22 and terminates at a bottom end of the injection channel 225. A first (bottom) end of the runner injection pin 245 includes a fixing head (not labeled) fixed to the ejector retainer plate 241, and a second (top) end of the runner injection pin 245 passes through the movable mold 22 and terminates at the runner 26.

Referring also to FIG. 3, in operation, the injection mold 20 is closed, and molten plastic is injected into the gate 213. The molten plastic passes through the runner 26 and the injection channel 225, and flows into the molding cavity 25. The molten plastic in the molding cavity 25 is solidified to form the plastic article 28. The molten plastic in the injection channel 225 is solidified to form excess material 27. Because the trimming edge 248 of the knockout pin 243 is adjacent to the injection channel 225 and the sharp tip of the trimming edge 248 protrudes into the top end of the injection channel 225, a sharp depression 29 is formed between the excess material 27 and the plastic article 28.

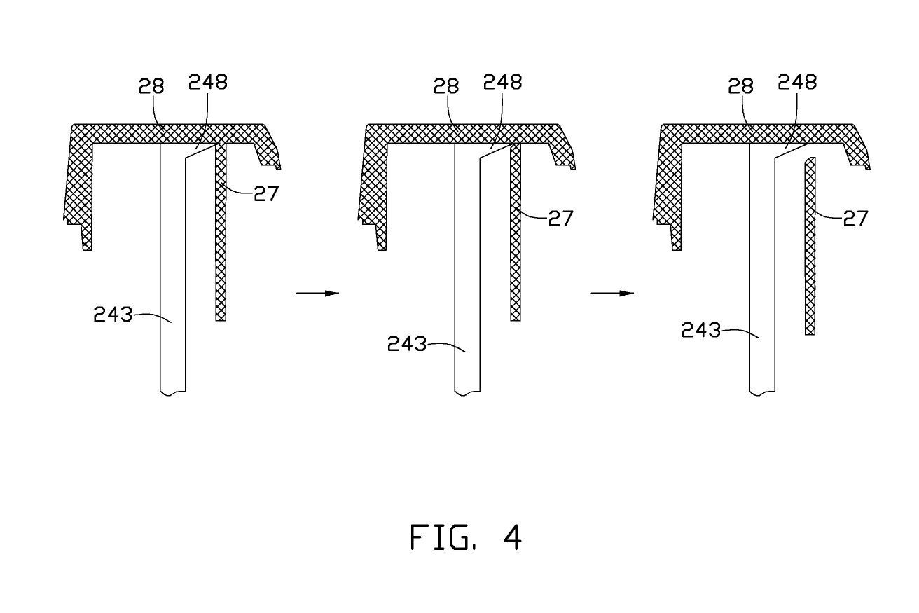

Referring also to FIG. 4, following solidification or settling of the molten material, the movable mold 22 is moved down and thereby detached from the stationary mold 21. The ejector retainer plate 241 pushes the knockout pin 243 to detach the plastic article 28 from the movable mold 22. The excess material 27 tends to be held in the injection channel 225 by adhesive force between the excess material 27 and the walls of the injection channel 225. Thus tension forces are generated in a region of the plastic body between the plastic article 28 and the excess material 27. The sharp depression 29 between the excess material 27 and the plastic article 28 has minimal or effectively no curvature, such that a portion of the plastic body adjacent to the sharp depression 29 is weakest and can easily split due to the tension force. Thus, the excess material 27 is easily detached from the plastic article 28. Then the sprue injection pin 244 of the ejector base plate 242 detaches the excess material 27 from the movable mold 22.

In summary, the injection mold 20 has the trimming edge 248 formed on the knockout pin 243, and the sharp tip of the trimming edge 24 protrudes into the top end of the injection channel 225 such that the sharp depression 29 is formed in the plastic body between the excess material 27 and the plastic article 28. The sharp depression 29 is a weak point and can be easily split by the tension forces acting in the region of the plastic body between the plastic article 28 and the excess material 27. Thus the excess material 27 is easily detached from the plastic article 28. No manual or machine cutting is required to separate the excess material 27, and the fabrication efficiency of the plastic article 28 made by the injection mold 20 is enhanced.

It should be pointed out that in alternative embodiments, the injection mold 20 may include more than one injection channel 225 and more than one corresponding knockout pin 243.

It is believed that the present embodiments and their advantages will be understood from the foregoing description, and it will be apparent that various changes may be made thereto without departing from the spirit and scope of the embodiments or sacrificing all of their material advantages.

What is claimed is:

1. An injection mold, comprising:
a stationary mold comprising a stationary core received therein, the stationary core comprising a stationary molding surface;
a movable mold comprising a movable core corresponding to the stationary core, wherein the movable core comprises a movable molding surface and defines an injection channel, and when the injection mold is closed the stationary molding surface and the movable molding surface cooperatively define a molding cavity of a configuration corresponding to that of an article to be molded, with the injection channel communicating with the molding cavity; and
an ejection device comprising a knockout pin passing through the movable mold and terminating at the molding cavity, the knockout pin comprising a trimming edge having a sharp tip protruding into a top end of the injection channel, such that a corner of the movable core where the injection channel communicates with the molding cavity is in the form of a sharp protrusion or ridge.

2. The injection mold of claim 1, wherein the stationary mold further comprises a stationary mold frame defining a receiving chamber in which the stationary core is received.

3. The injection mold of claim 1, wherein the stationary core further comprises a stationary runner surface adjoining the stationary molding surface, the stationary mold defines a gate through the stationary mold frame and the stationary core, and the gate communicates with the runner surface; the movable core further comprises a movable runner surface adjoining the movable molding surface; and when the injection mold is closed the stationary runner surface and the movable runner surface cooperatively define a runner communicating with the gate, with a first end of the injection channel communicating with the molding cavity, and a second end of the injection channel communicating with the runner.

4. The injection mold of claim 3, wherein the ejection device further comprises an ejector retainer plate to which a first end of the knockout pin is fixed; and a second end of the knockout pin passes through the movable mold, and when the injection mold is closed the second end of the at least one knockout pin terminates at the molding cavity.

5. The injection mold of claim 4, wherein the ejection device further comprises an ejector base plate parallel and adjacent to the ejector retainer plate, and a sprue injection pin; a first end of the sprue injection pin comprises a fixing head fixed to the ejector base plate; and a second end of the sprue injection pin passes through the movable mold and terminates at a bottom end of the injection channel.

6. The injection mold of claim 1, wherein the injection channel is defined in the movable core in a direction parallel to a direction of movement of the movable mold, and spans to a topmost portion of the movable molding surface.

7. The injection mold of claim 1, wherein the sharp tip of the trimming edge protrudes slightly into the top end of the injection channel.

8. An injection mold, comprising:
a stationary mold comprising a stationary mold frame and a stationary core received in the stationary mold frame, the stationary mold defining a gate through the stationary mold frame and the stationary core, the stationary core comprising a stationary molding surface;
a movable mold comprising a movable core corresponding to the stationary core, wherein the movable core comprises a movable molding surface and defines an injection channel; and when the injection mold is closed the stationary molding surface and the movable molding surface cooperatively define a molding cavity of a configuration corresponding to that of an article to be molded, with the injection channel communicating with the molding cavity; the stationary core and the movable core cooperatively defining a runner communicating with the gate, and the injection channel communicating with the molding cavity and the runner;
a mold base supporting the stationary mold and the movable mold; and
an ejection device positioned between the movable mold and the mold base, the ejection device comprising at least one knockout pin passing through the movable mold and terminating at the molding cavity, the knockout pin comprising a trimming edge having a sharp tip protruding into a top end of the injection channel.

9. The injection mold of claim 8, wherein the stationary mold further comprises a stationary mold frame defining a receiving chamber in which the stationary core is received.

10. The injection mold of claim 8, wherein the ejection device further comprises an ejector retainer plate to which a first end of the at least one knockout pin is fixed; and a second end of the at least one knockout pin passes through the movable mold, and when the injection mold is closed the second end of the at least one knockout pin terminates at the molding cavity.

11. The injection mold of claim 10, wherein the ejection device further comprises an ejector base plate parallel and adjacent to the ejector retainer plate, and a sprue injection pin; a first end of the sprue injection pin comprises a fixing head fixed to the ejector base plate; and a second end of the sprue injection pin passes through the movable mold and terminates at a bottom end of the injection channel.

12. The injection mold of claim 8, wherein the injection channel is defined in the movable core in a direction parallel to a direction of movement of the movable mold, and spans to a topmost portion of the movable molding surface.

13. The injection mold of claim 8, wherein the sharp tip of the trimming edge protrudes slightly into the top end of the injection channel.
